(19) United States
(12) Patent Application Publication
(10) Pub. No.: US 2026/0149591 A1
(43) Pub. Date: May 28, 2026

(54) METHOD FOR MANAGING SECRET INFORMATION IN SECRET INFORMATION MANAGEMENT SYSTEM COMPOSED OF COMPUTING DEVICES AND COMPUTING DEVICE FOR PERFORMING THE SAME

(71) Applicant: Atomrigs Lab Inc., Seoul (KR)

(72) Inventors: Kyoung Il Bae, Seoul (KR); Woo Hyeon Cheong, Seoul (KR); Sang Min Kim, Seoul (KR)

(73) Assignee: Atomrigs Lab Inc., Seoul (KR)

(21) Appl. No.: 19/392,294

(22) Filed: Nov. 18, 2025

(30) Foreign Application Priority Data
Nov. 25, 2024 (KR) 10-2024-0169716

(51) Int. Cl. H04L 9/32; H04L 9/08

(52) U.S. Cl. CPC H04L 9/3228; H04L 9/085; H04L 9/0869

(57) ABSTRACT

The present disclosure relates to a method for managing secret information. The method for managing secret information in a secret information management system comprising a computing device comprises receiving a first secret share from among a plurality of secret shares for a secret key, a first additive share from among additive shares for the secret key, and a public key for the secret key by using a first terminal; generating a temporary key using the received public key as a coefficient for a random number; generating encrypted information by encrypting the secret information using an encryption key derived from the random number and the public key; storing the received first additive share and the public key in a database of the first terminal; and transmitting the generated temporary key and the encrypted information to a first server that possesses a second secret share and a second additive share.

### BACKGROUND

### 1. Field

The present disclosure relates to a method for managing secret information.

### 2. Description of Related Art

Recently, services such as Google Password Manager and the Apple Passwords app provide functions that help users safely manage secret information, such as passwords for various accounts.

These services allow users to store and manage login information for websites or applications, thereby allowing the service to automatically enter the information without requiring users to remember each account password. This allows users to safely store passwords and easily log in.

Users'secret information may be synchronized across multiple devices. For example, a cloud-based synchronization function allows users to use passwords stored on their smartphones even on their laptops and tablets. Users may easily use the same passwords on all devices without having to store the passwords on each device again.

Even if users lose their previous device, they may restore their secret information on a new device. It supports storing passwords in the cloud and allows users to restore the stored passwords on other devices after completing authentication through a security procedure. Accordingly, this provides convenience by enabling password recovery even in the event of the device loss.

However, despite this convenience, there are security concerns regarding the possibility that operators like Google or Apple may access user confidential information. In the cloud-based synchronization systems, the password information is stored and synchronized on the cloud server, there may be a risk that this data is not protected or may be accessed by third parties.

While these services offer convenience to users, they also require consideration of cloud-based security and the prevention of unauthorized access to confidential information.

### SUMMARY

The present disclosure enhances the security of user confidential information while providing convenient information management functions to users. To this end, the present disclosure provides a distributed security method utilizing multiple private key shares for the encryption of confidential information, thereby reducing the risk of the service server directly accessing user confidential information.

Specifically, the present disclosure encrypts confidential information, such as passwords, and stores the confidential information encrypted information, thereby preventing the service server from directly accessing the confidential information. In this case, the private key used for encryption is distributed and managed as a private share, and the public key of the private key is used for encryption, thereby enhancing security.

Furthermore, the present disclosure enables flexible security management based on sensitivity of user's confidential information by directly accessing less sensitive confidential information offline and encrypting sensitive confidential information online.

Through this, the present disclosure provides users with the convenience of safely synchronizing confidential information across multiple devices and restoring confidential information the event of loss, while minimizing the risk of confidential information exposure by the service server on its own and maintaining an appropriate level of security in both offline and online situations.

According to an aspect of the present disclosure, a method for managing secret information in secret information management system composed of computing devices performed in a computing device according to an embodiment of the present disclosure may receive a first secret share from among a plurality of secret shares for a secret key, a first additive share from among additive shares for the secret key, and a public key for the secret key by using a first terminal. A temporary key may be generated using the received public key as a coefficient for a random number, and encrypted information may be generated by encrypting the secret information using an encryption key derived from the random number and the public key. The received first additive share and the public key may be stored in a database of the first terminal, and the generated temporary key and the encrypted information may be transmitted to a first server that possesses a second secret share and a second additive share.

Authentication may be performed using secret information stored in the database.

The temporary key and the encrypted information may be stored in the database, and the temporary key, the first additive share, and the encrypted information may be extracted from the database. A first operation result of the temporary key and the second additive share transmitted from the first server may be requested and received, the secret information may be generated by decrypting the encrypted information using a second operation result of the first additive share and the temporary key and the received first operation result, and the authentication may be performed using the generated secret information.

A generation of a new secret share for the secret key may be requested using a second terminal different from the first terminal, and a newly generated 1-1st secret share using a previously generated second secret share and third secret share for the secret key, a 1-1st additive share among the additive shares for the secret key, and a public key for the secret key may be received in response to the request. The received 1-1st additive share and public key may be stored in a database of the second terminal.

The temporary key and the encrypted information transmitted by the first terminal may be received from the first server, and the received temporary key and encrypted information may be stored in the database of the second terminal.

The temporary key, the 1-1st additive share, and the encrypted information may be extracted from the database of the second terminal, and a 1-1st operation result of the temporary key and a 2-1st additive share may be requested and received from the first server. The secret information may be generated by decrypting the extracted encrypted information using the 1-1st additive share, the 2-1st operation result of the temporary key, and the received 1-1st operation result, and the generated secret information may be stored in the database of the second terminal.

The first server and the second server, which possesses the third secret share, may generate the 1-1st secret share using the second secret share and the third secret share.

### BRIEF DESCRIPTION OF DRAWINGS

FIG. 1 is a conceptual diagram illustrating a configuration of a multi-terminal signature system using secret key shares according to an embodiment of the present disclosure.

FIG. 2 is a flowchart illustrating a multi-terminal signature process using secret key shares according to an embodiment of the present disclosure.

FIG. 3 is an exemplary diagram illustrating a configuration of a group performing a signature process among multiple terminals using secret key shares according to an embodiment of the present disclosure.

FIG. 4 is a flowchart illustrating a process of generating derived secret key shares for the signature among multiple terminals using secret key shares according to an embodiment of the present disclosure.

FIG. 5 is a flowchart illustrating a process for transmitting shared information for the signature among multiple terminals using secret key shares according to an embodiment of the present disclosure.

FIG. 6 is a flowchart illustrating an identification and authentication process for the signature among multiple terminals using the secret key shares according to an embodiment of the present disclosure.

FIGS. 7 and 8 are flowcharts illustrating a post-identification processing process for the signature among multiple terminals using the secret key shares according to an embodiment of the present disclosure.

FIG. 9 is a flowchart illustrating a signature process of generating derived secret key shares for the signature among multiple terminals using the secret key shares according to an embodiment of the present disclosure.

FIG. 10 is an exemplary diagram illustrating an implementation in the form of a computing device of a task execution server including a language model according to an embodiment of the present disclosure.

FIG. 11 is a flowchart illustrating the key recovery operation of a second user terminal according to an embodiment of the present disclosure.

FIG. 12 is a flowchart illustrating the secret information restoration process according to an embodiment of the present disclosure.

FIG. 13 shows a user terminal implemented in the form of the computing device.

### DETAILED DESCRIPTION

The following description illustrates only a principle of the present disclosure. Therefore, those skilled in the art may implement the principle of the present disclosure and invent various devices included in the spirit and scope of the present disclosure although not clearly described or shown in the present specification. In addition, it is to be understood that all conditional terms and exemplary embodiments mentioned in the present specification are obviously intended only to allow those skilled in the art to understand a concept of the present disclosure in principle, and the present disclosure is not limited to exemplary embodiments and states particularly mentioned as such.

The above-mentioned objects, features, and advantages will become more obvious from the following detailed description provided in relation to the accompanying drawings. Therefore, those skilled in the art to which the present disclosure pertains may easily practice a technical idea of the present disclosure.

Further, in describing the present disclosure, if it is judged that a detailed description of a well-known technology associated with the present disclosure may unnecessarily make the gist of the present disclosure unclear, it will be omitted. Hereinafter, embodiments of the present disclosure will be described in detail with reference to the accompanying drawings.

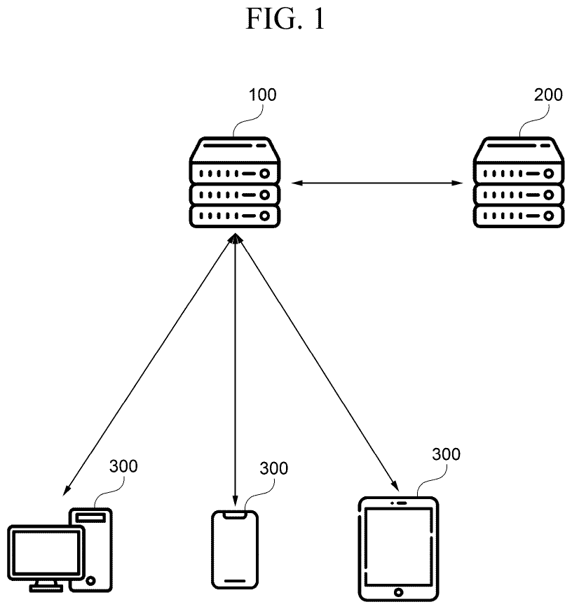

Referring to FIG. 1, a system according to the present embodiment may be composed of a user terminal and a server to ensure the security and convenient management of user's secret information.

The first user terminal 300 is a personal terminal that a user may directly access and control, and may be an entity responsible for managing the secret information.

The first user terminal 300 may encrypt secret information, such as passwords, and store or request encrypted secret information for access.

In the present embodiment, the first user terminal 300 may directly access low-sensitivity secret information in an offline state, and secure the safety of the secret information in the online state by encrypting and storing the secret information on the server.

The system according to the present embodiment manages the secret key share required for encryption in a distributed manner across the first server 100 and the second server 200, thereby allowing the user to safely access the encrypted information when needed.

The first server 100 may support information management and synchronization without directly storing the user's secret information.

The first server 100 functions as a cloud service that safely stores and manages users'secret information without directly exposing the user's secret information. This facilitates the synchronization, backup, and restoration of user information, and allows the user to access the same secret information from multiple devices.

The passwords and secret information entered by users may be encrypted and stored. Since the secret information is stored only in an encrypted state, the server operator may not access the actual secret information.

The first server 100 may support information synchronization with other users'devices, thereby allowing the user to conveniently access the secret information from multiple devices. For example, the first server 100 may maintain security by allowing only necessary information to be accessed after user authentication, similar to account-based cloud services from Google or Apple.

The first server 100 provides additional authentication methods (e.g., 2FA, biometrics) upon access, thereby protecting the user's secret information from exposure by external intrusions.

Specifically, the first server 100 according to the present embodiment may share a secret key share with the first user terminal 300 and the second server 200 according to the Shamir secret sharing scheme. The Shamir secret sharing scheme prevents the secret key from being concentrated in a single location.

The first server 100 enhances security by restricting access to user data and maintaining the data itself in the encrypted state. Furthermore, the secret share management prevents the service operator from restoring secret information, thereby maximizing user privacy.

As described above, the first server 100 also provides users with convenient synchronization and restoration functions linked to the second server 200 while enhancing the secure data management and secret information protection.

By storing and managing only the encrypted secret information on the first user terminal 300, the user's secret information is protected from direct exposure to the server, thereby minimizing the possibility of exposing the secret information to the outside.

Additionally, the first server 100 maintains the secret key share in accordance with the Shamir secret sharing scheme together with the first user terminal 300 and the second server 200, and may perform a key distribution role for restoring the encrypted secret information.

That is, the second server 200 functions as an auxiliary server to enhance the security of secret information between the first user terminal 300 and the first server 100.

The second server 200 stores and manages a portion of the secret key share in accordance with the Shamir secret sharing scheme. The second server 200 cooperates with the first server 100 to support the restoration of encrypted information only when necessary for the first or second user terminal 300′. Even in this case, individual servers are prevented from restoring the entire secret key.

The distributed management structure utilizing the second server 200 reduces the risk of the service server directly accessing the user's secret information and enhances the security of the entire system by encrypting the entire system using the public key of the secret key.

The system of the present disclosure enhances the security of the user's secret information by encrypting the secret information and distributing the secret share management among the first user terminal 300, the first server 100, and the second server 200, while enabling convenient synchronization and restoration across various devices.

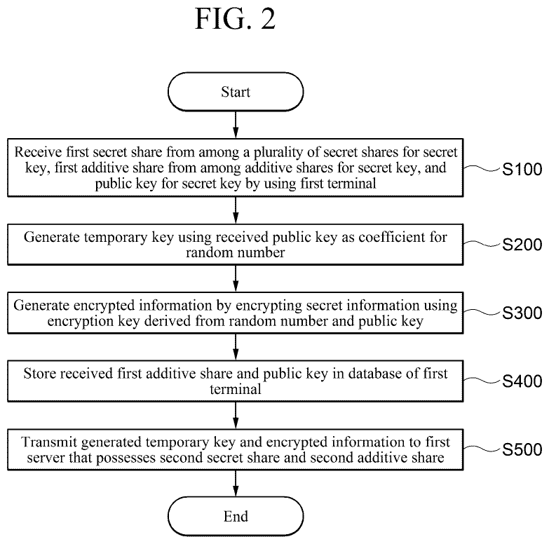

Hereinafter, a method for managing secret information according to the present embodiment will be described with reference to FIG. 2.

Each step of the method for managing secret information of the present disclosure includes distributed key generation and encryption for safely managing the user's secret information.

First, the first user terminal 300 receives a first secret share, a first additive share, and a public key (S100).

The first user terminal 300 receives a first secret share s1, which is one of the distributed shares for the secret key s, an additive share w1, and a public key Pubkey. Here, the first secret share s1 may be one of the shares created by splitting the secret key s using the Shamir secret sharing scheme (SSS).

The first user terminal 300 and the first and second servers 200 generate secret shares s1, s2, and s3 by splitting the secret key s into 2-3 combinations using a distributed key generation (DKG) protocol.

In the present embodiment, the public key is calculated as PubKey=s×G (where G is a fixed generator value), which may be generated based on the secret key.

Additionally, additive shares w1 and w2 may be generated as combinations of the secret key s, such that w1+w2=s. This may be used as an additional security measure to prevent the secret key from being concentrated in a single share.

Next, the first user terminal 300 generates a temporary key using the received public key as a coefficient of a random number (S200).

The first user terminal 300 may generate a random number b and calculate a temporary key B as follows:

$$B = b \times G \qquad [ Equation 1 ]$$

Here, G is a fixed generator used in public key generation.

Since b is a random number, a temporary key B is newly generated each time, thereby enhancing security.

The first user terminal 300 combines the generated random number with the public key.

The first user terminal 300 generates the encrypted information by encrypting secret information using an encryption key derived from the random number and the public key.

The first user terminal 300 may derive an encryption key using the temporary key B and the public key PubKey for generating the encryption key (key=KDF(b×PubKey)).

Here, b×PubKey is equal to b×(s×G), and the first user terminal 300 may use this as input while generating a derived value using a key derivation function (KDF).

The first user terminal 300 encrypts the secret information using the derived encryption key. The encryption key is used during this encryption process, and the encrypted result is stored as the encrypted information.

$$cipher = Encrpt ( secret , key ) \qquad [ Equation 2 ]$$

Here, the encrypt function encrypts the secret information (secret) using the encryption algorithm (such as AES) to generate the encrypted information (cipher).

The first user terminal 300 generates a temporary key B using the random number b and encrypts the secret information using the derived encryption key to generate the encrypted information (S300).

The first user terminal 300 safely stores the received first additive share w1 and the public key PubKey in the database (S400).

The first additive share w1 is a partial component of the secret key s, and may be one of the shares capable of restoring the secret key along with another additive share w2.

The first user terminal 300 transmits the generated temporary key B and the encrypted secret information to the first server 100, which possesses the second secret share and the second additive share (S500).

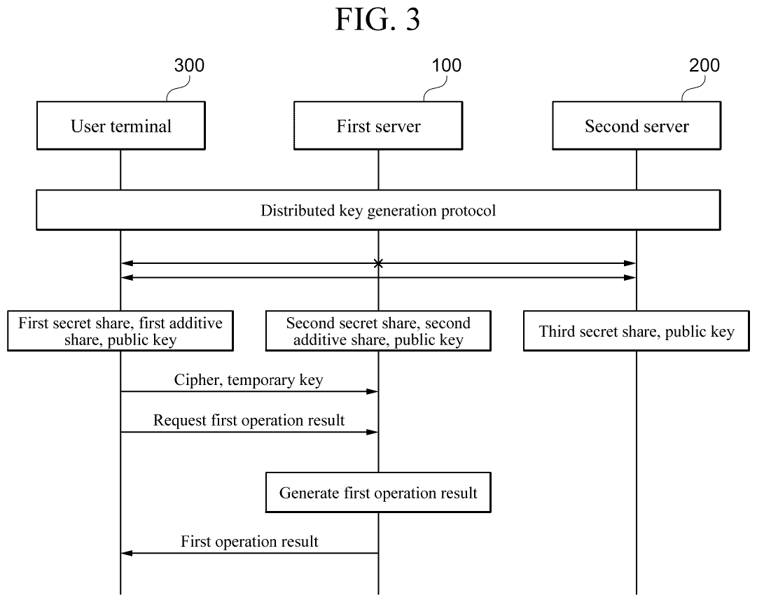

The operation timing of each component will be described in detail with reference to FIG. 3.

FIG. 3 is a diagram illustrating the linkage process between the first user terminal 300, the first server 100, and the second server 200 according to an embodiment of the present disclosure.

FIG. 3 illustrates the flow of a process for safely encrypting the secret information using the distributed key generation protocol in the secret information management system according to the present embodiment, and storing and restoring the encrypted information on the server.

Each component (user terminal, first server 100, second server 200) of the system may manage the key shares for the secret information in the distributed manner.

The user terminal, the first server 100, and the second server 200 share the share of the secret key through the distributed key generation protocol and generate the public key. During this process, a sharing method may be used to prevent the secret key from being directly stored on the server.

The secret key share and public key generated through the distributed key generation protocol are distributed and stored on each server and the first user terminal 300.

The first user terminal 300 receives the first secret share, the first additive share, and the public key.

The first server 100 possesses the second secret share, the second additive share, and the public key.

The second server 200 holds a third secret share, a third additive share, and a public key.

Security may be enhanced by storing the secret key in the distributed manner on each server and user terminal.

As described above, the first user terminal 300 generates the temporary key B using the random number b and derives the encryption key using the KDF based on the public key.

The first user terminal 300 encrypts the secret information using the derived encryption key and generates the cipher from the encrypted result.

The first user terminal 300 safely stores the additive share w1 and the public key PubKey in the database within the device.

Furthermore, the first user terminal 300 transmits the cipher and the temporary key to the first server 100.

Furthermore, the first user terminal 300 may store the temporary key and the encrypted information in the database (S400).

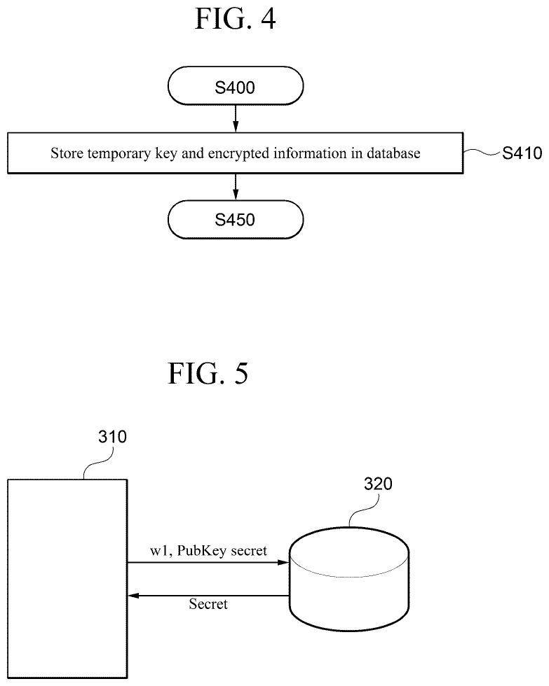

Referring to FIG. 4, the generated temporary key B and the encrypted secret information cipher are stored in the database of the first user terminal 300.

In this case, the system according to the present embodiment provides authentication methods in which the first user terminal 300 stores the secret information in addition to the temporary key B and the encrypted secret information, to enhance the security of the user's secret information and provide the online/offline authentication.

In the present embodiment, the server may flexibly provide online/offline authentication methods depending on the situation.

Referring to FIG. 5, the user terminal may store the secret information itself.

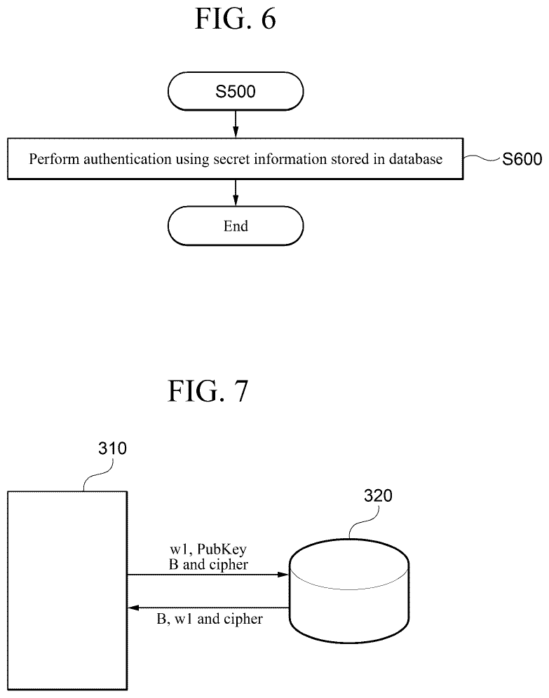

Referring also to FIG. 6, the first method enables the offline authentication by having the user terminal store the secret information (secret) itself in the database 320 (S600). That is, this allows the user to access the secret information stored in the terminal even when the network connection is unstable or offline.

In this case, since the secret information itself is not stored on the server, even if the server is hacked, the secret information is not directly exposed. Furthermore, the authentication is possible even in offline environments, enhancing user convenience.

Also, referring to FIG. 7, the first user terminal 300 may store the temporary key and the cipher information.

The first user terminal 300 stores the encrypted secret information in the processor 310 and stores the temporary key, the first additive share, and the public key in the database 320.

In the second method, the operation participation of the server may be required to recover the secret information.

The server performs the necessary operations upon a user authentication request using a pre-received temporary key and transmits the corresponding results to the user terminal.

The second method according to the present embodiment may operate based on the online authentication. The user should connect to the server to access the secret information, and the server supports the authentication process through the operation. The second method enables real-time authentication without exposing the secret information to the server in the online environment.

Since the first user terminal 300 performs the authentication process in cooperation with the server and the user in an online state, the secret information may be protected from external threats.

To flexibly provide the online/offline authentication methods, the server splits and uses the data management method into two cases. The server allows users to safely perform the authentication even in the offline environment and allows users to perform the authentication through a real-time connection with the server while online.

In this way, the system according to the present embodiment provides a flexible authentication system that selectively enhances both the user convenience and security.

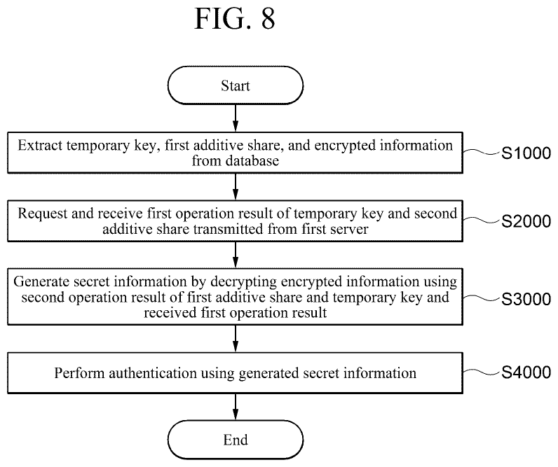

Specifically, the second method, which is linked to the server, will be described in detail with reference to FIG. 8.

Referring to FIG. 8, the temporary key, the first additive share, and the encrypted information are extracted from the database (S1000).

The first user terminal 300 extracts the necessary information from the database. This information includes the temporary key B, the first additive share w1, and the encrypted secret information.

The first user terminal 300 uses this information to set initial conditions necessary for the secret information restoration and prepares for the decryption operation.

The first user terminal 300 requests and receives the first operation result for the temporary key and the second additive share from the first server 100 (S2000). The first user terminal 300 requests the operation result using the temporary key B and the second additive share w2 from the first server 100. The first server 100 may multiply its own additive share w2 by the temporary key B to obtain the first operation result as follows.

$$First Operation Result = w 2 \times B \qquad [ Equation 3 ]$$

The first user terminal 300 enables the first server 100 to support the authentication process without accessing the secret key s or the secret information through this operation.

The first user terminal 300 prepares for the secret information decryption by combining the product of one additive share and the temporary key with the first operation result. The user terminal calculates the result by multiplying its own additive share w1 by the temporary key B, and then combines the first operation result received from the first server 100 as shown in Equation below.

$$w 1 \times B + First Operation Result = ( w 1 + w 2 ) \times B = s \times B \qquad [ Equation 4 ]$$

This value is a shared secret used to generate the decryption key and is used to derive the encryption key required to restore the secret information.

The first user terminal 300 derives the decryption key and decrypts the secret information.

The user terminal inputs a s×B value to the key derivation function (KDF) to derive the decryption key.

$$key = KDF ( s \times B ) \qquad [ Equation 5 ]$$

The key according to Equation 5 is the encryption key derived from the secret key s and the temporary key B and is used to decrypt the secret information.

The first user terminal 300 uses the derived key to decrypt the encrypted cipher to generate the secret information (secret) (S3000).

$$Secret = Decrypt ( Cipher , key ) \qquad [ Equation 6 ]$$

Through this process, the original secret information is restored.

The first user terminal 300 performs the authentication using the generated secret information (S4000).

The first user terminal 300 performs the user authentication based on the decrypted secret information. The restored secret information is used as data for user identification, thereby allowing the final authentication process to be completed.

The following describes a method re-registering a user terminal due to loss, change, etc.

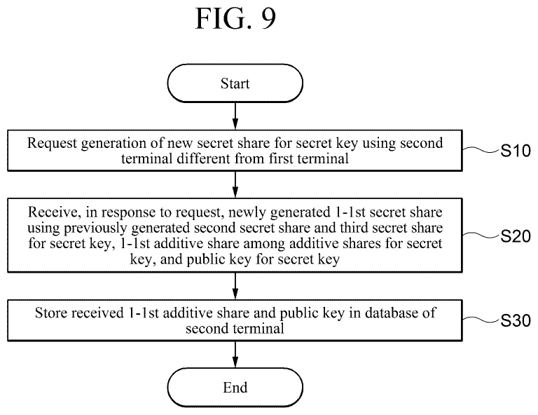

FIG. 9 is a flowchart illustrating a new registration method using key recovery according to an embodiment of the present disclosure.

First, depending on the loss of the first user terminal 300, a different first user terminal 300 requests the generation of the 1-1st secret share and the 1-1st additive share (S10).

A second user terminal 300′ should generate a new secret share because the first user terminal 300 has been discarded. To this end, the second user terminal 300′ may request a new secret share for the secret key through communication with the first server 100 and the second server 200.

The second user terminal 300′ generates a new share while maintaining the existing secret key, and inherits the role of the first user terminal 300 to o perform authentication and decryption.

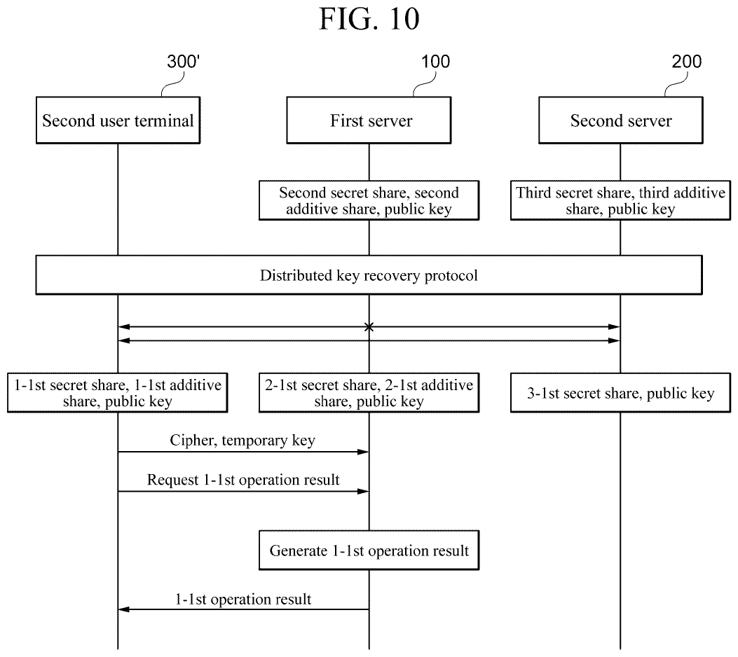

FIG. 10 is a diagram illustrating the key recovery process through the linkage between the first user terminal 300, the first server 100, and the second server 200 according to an embodiment of the present disclosure.

The first server 100 and the second server 200 generate a new 1-1st secret share and a 1-1st additive share using the previously distributed secret key shares (the 2nd secret share and the 3rd secret share), and transmit the 1-1st secret share and 1-1st additive share to the second user terminal 300′.

In response to the request, the second user terminal 300′ receives the newly generated 1-1st secret share using the previously generated second secret share and the third secret share for the secret key, the 1-1st additive share among the additive shares for the secret key, and the public key for the secret key (S20).

The new 1-1st secret share and 1-1st additive share maintain the existing secret key and may be used to restore the secret key, along with the shares held by existing servers.

Since the servers safely transmit and generate new shares without exposing the original secret key, the security of the secret key is maintained.

The second user terminal 300′ stores the 1-1st additive share and the public key in its database (S30). Since the first user terminal 300 has been discarded, the second user terminal 300′ may provide the same level of authentication and recovery functionality as the existing secret key through the new secret share.

The stored 1-1st additive share and the public key may be used as the shares required for subsequent authentication procedures or secret information restoration.

In this case, in the present embodiment, the necessary data is transferred and configured to enable continued authentication based on the existing secret key through the second user terminal 300′ after the first user terminal 300 has been discarded.

The system according to the present disclosure safely receives the existing encrypted information, thereby preparing the second user terminal 300′ to inherit the role of the first user terminal 300.

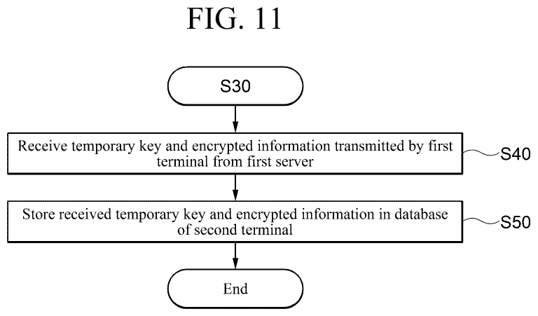

FIG. 11 is a flowchart illustrating the key recovery operation of the second user terminal 300′ according to an embodiment of the present disclosure.

Referring to FIG. 11, the second user terminal 300′ receives the temporary key and encrypted information previously transmitted from the first user terminal 300 through the first server 100 (S40).

The second user terminal 300′ receives the temporary key B and encrypted information cipher previously transmitted by the first user terminal 300 from the server. The received information is essential data for the secret information recovery and may be transmitted in the encrypted state generated by the first user terminal 300.

By transmitting the temporary key and password information used by the first user terminal 300 to the second user terminal 300′ when encrypting the secret information, the preparations for restoring the existing secret information are completed. The system according to the present embodiment ensures continuity of access to the existing secret information even when the first user terminal 300 is discarded.

Since the contents of this data are unknown to the first server 100, the first server 100 simply stores and transmits the temporary key and password information, thereby maintaining the security of the secret information.

The second user terminal 300′ stores the received temporary key in its database (S50).

The second user terminal 300′ safely stores the temporary key B received from the server in its database. The temporary key is an important value used in the password information restoration process and is subsequently utilized in authentication and secret information decryption processes. By storing the temporary key, the second user terminal 300′ is ready to inherit the secret information decryption and authentication functions previously performed by the first user terminal 300.

The second user terminal 300′ may inherit access rights to the existing secret information. In this case, the database of the second user terminal 300′ may store not only the temporary key, but also the 1-1st secret share, additive share, and public key described above. This information, which serves as shares required for authentication, is safely managed.

Through this process, even after the first user terminal 300 is discarded, the existing secret information may be safely accessed, and the second user terminal 300′ may inherit the existing secret key-based authentication function, thereby maintaining service continuity.

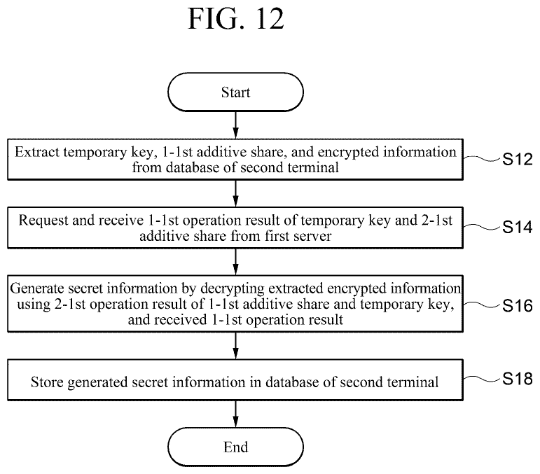

Next, a method for restoring secret information will be described with reference to FIG. 12.

FIG. 12 is a flowchart illustrating the secret information restoration process.

Referring to FIG. 12, the second user terminal 300′ extracts the temporary key, the 1-1st additive share, and the password information from the database (S12).

The second user terminal 300′ extracts information necessary for authentication from the database. This may include the temporary key B, the 1-1st additive share w1-1st, and the encrypted secret information.

The second user terminal 300′ uses the extracted information to perform initial settings necessary for secret information restoration and prepares for authentication.

The second user terminal 300′ requests and receives the temporary key and the 1-1st operation result of the 2-1st additive share from the first server 100 (S14).

The second user terminal 300′ requests an operation from the first server 100 using the temporary key B and the 2-1st additive share w2-1st. The first server 100 multiplies its 2-1st additive share w2-1st by the temporary key B to calculate the 1-1st operation result (First-First Operation Result) using the following Equation.

$$First - First Operation Result = w 2 - 1 st \times B \qquad [ Equation 6 ]$$

The first server 100 transmits the operation result to the second user terminal 300′, which then obtains the information necessary for the decryption process. The first server 100 may safely participate in the decryption process without knowing the secret key s.

The second user terminal 300′ decrypts the extracted encrypted information using the 1-1st additive share, the 2-1st operation result of the temporary key, and the received 1-1st operation result, thereby generating the secret information (S16).

The second user terminal 300′ calculates the operation result by multiplying its own additive share w1-1st, by the temporary key B, and then combines it with the 1-1st operation result received from the first server 100.

$$w 1 - 1 st \times B + First - First Operation Result = ( w 1 - 1 st + w 2 - 1 s t ) \times B = s \times B \qquad [ Equation 7 ]$$

Here,
since w1-1st+w2-1st=s, s×B may be obtained.

The value calculated according to Equation 7 is input into the key derivation function (KDF) to derive the encryption key required for decryption.

The second user terminal 300′ decrypts the encrypted secret information using the derived key to generate the original secret information.

Then, the second user terminal 300′ stores the generated secret information in the database and performs the authentication (S18).

The second user terminal 300′ finally completes the authentication using the restored secret information. This allows the second user terminal 300′ to successfully perform the authentication based on the existing secret key, even though the first user terminal 300 has been discarded.

The present disclosure relates to a subscription management system that enhances security and provides user convenience by encrypting and storing the user's secret information. By splitting and distributing the secret key into multiple shares, the access to the secret information is only possible when a certain number of shares are gathered, thereby enhancing the security and reducing the risk of the service server directly accessing the secret information. Furthermore, by encrypting and storing the sensitive information on the server in the online state and using the less sensitive information in the offline state, the system may simultaneously provide the security and convenience.

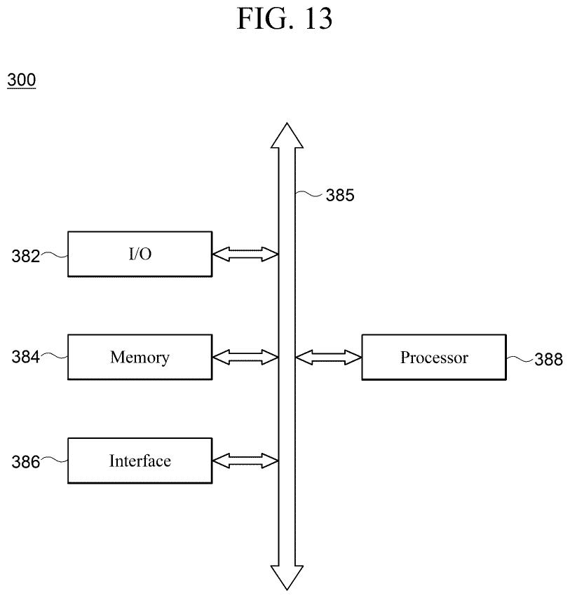

Referring to FIG. 13, in some embodiments of the present disclosure, the user terminal 300 may be implemented in the form of the computing device. One or more modules constituting the terminal 300 are implemented on a general-purpose computing processor and may therefore include a processor 388, an input/output I/O device 382, a memory 384, an interface 386, and a bus 385. The processor 388, the input/output (I/O) device 382, the memory 384, and/or the interface 386 may be coupled to each other via the bus 385. The bus 385 corresponds to a path through which data is transferred.

Specifically, the processor 388 may include at least one of a central processing unit (CPU), a micro processor unit (MPU), a micro controller unit (MCU), a graphic processing unit (GPU), a microprocessor, a digital signal processor, a microcontroller, an application processor (AP), and logic devices capable of performing functions similar thereto.

The input/output device 382 may include at least one of a keypad, a keyboard, a touchscreen, and a display device. The memory 384 may store data and/or programs, etc.

The interface 386 may perform a function of transmitting or receiving data to and from a communication network. The interface 386 may be a wired or wireless form. For example, the interface 386 may include an antenna, a wired/wireless transceiver, etc. The memory 384 may further include high-speed DRAM and/or SRAM, etc., as volatile operating memory that enhances the operation of the processor 388 and protects personal information.

In addition, the memory 384 stores programming and data configurations that provide the functionality of some or all of the modules described herein. For example, the memory 384 may include logic that performs selected aspects of the learning method described above. A program or application is loaded as a set instructions containing each operation for performing the learning method described above stored in the memory 384, and the processor is configured to perform each operation.

Hereinabove, various exemplary embodiments described herein may be implemented in a recording medium that is readable by a computer or a device similar to the computer using, for example, software, hardware, or a combination thereof.

According to a hardware implementation, the embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions. In some cases, the embodiments described in the disclosure may be implemented by the control module itself.

According to the software implementation, embodiments such as procedures and functions described in the disclosure may be implemented by separate software modules. Each of the software modules may perform one or more functions and operations described in the disclosure. The software code may be implemented as a software application written in a suitable programming language. The software code may be stored in the memory module and executed by the control module.

According to the present disclosure, it is possible to fixedly manage user confidential information while providing a high level of convenience to users.

According to the present disclosure, by encrypting and storing the confidential information, it is possible to reduce the risk of the service server directly accessing the user's confidential information. The encryption uses the public key of a secret key, which is distributed and managed as secret shares, thereby enhancing encryption security without exposing the secret key.

According to the present disclosure, by splitting the secret key into multiple shares and managing the multiple shares in a distributed manner, it is possible to ensure that only a certain number of secret key shares may access the original confidential information. This reduces the possibility of confidential information being accessed from the single server or specific device, thereby enhancing the security.

According to the present disclosure, by directly using the less sensitive information in the offline state, while encrypting the sensitive secret information in the online state, it is possible to adopt a method in which only encrypted data is stored on or shared with the service server. Through this, by applying appropriate the security levels, it is possible to minimize the risk of confidential information exposure while facilitating convenient information management.

According to the present disclosure, it is possible to provide a function for safely synchronizing confidential information across multiple devices in encrypted form. Furthermore, by restoring the secret information from the lost device on another device using the secret key shares, it is possible to allow the user to retain access to their secrets while maintaining security.

According to the present disclosure, it is possible to significantly enhance the security of user confidential information while also providing the convenience in managing and restoring the confidential information across various devices. This reduces the potential risk of service providers accessing user confidential information and provides users with a method for managing confidential information in a more secure environment.

The spirit of the present disclosure has been described only by way of example hereinabove, and the present disclosure may be variously modified, altered, and substituted by those skilled in the art to which the present disclosure pertains without departing from essential features of the present disclosure.

Accordingly, the exemplary embodiments disclosed in the present disclosure and the accompanying drawings do not limit but describe the spirit of the present disclosure, and the scope of the present disclosure is not limited by the exemplary embodiments and the accompanying drawings. The scope of the present disclosure should be interpreted by the following claims and it should be interpreted that all spirits equivalent to the following claims fall within the scope of the present disclosure.

What is claimed is:

1. A method for managing secret information in a secret information management system comprising a computing device, comprising:
receiving a first secret share from among a plurality of secret shares for a secret key, a first additive share from among additive shares for the secret key, and a public key for the secret key by using a first terminal;
generating a temporary key using the received public key as a coefficient for a random number;
generating encrypted information by encrypting the secret information using an encryption key derived from the random number and the public key;
storing the received first additive share and the public key in a database of the first terminal; and
transmitting the generated temporary key and the encrypted information to a first server that possesses a second secret share and a second additive share.

2. The method of claim 1, further comprising:
performing authentication using secret information stored in the database.

3. The method of claim 2, further comprising:
storing the temporary key and the encrypted information in the database,
wherein the performing of the authentication includes:
extracting the temporary key, the first additive share, and the encrypted information from the database;
requesting and receiving a first operation result of the temporary key and the second additive share transmitted from the first server;
generating the secret information by decrypting the encrypted information using a second operation result of the first additive share and the temporary key and the received first operation result; and
performing authentication using the generated secret information.

4. The method of claim 1, further comprising:
requesting a generation of a new secret share for the secret key using a second terminal different from the first terminal;
receiving, in response to the request, a newly generated 1-1st secret share using a previously generated second secret share and third secret share for the secret key, a 1-1st additive share among the additive shares for the secret key, and a public key for the secret key; and
storing the received 1-1st additive share and a public key in a database of the second terminal.

5. The method of claim 4, further comprising:
receiving the temporary key and the encrypted information transmitted by the first terminal from the first server; and
storing the received temporary key and encrypted information in the database of the second terminal.

6. The method of claim 5, further comprising:
extracting the temporary key, the 1-1st additive share, and the encrypted information from the database of the second terminal;
requesting and receiving a 1-1st operation result of the temporary key and a 2-1st additive share from the first server;
generating the secret information by decrypting the extracted encrypted information using the 2-1st operation result of the 1-1st additive share and the temporary key, and the received 1-1st operation result; and
storing the generated secret information in the database of the second terminal.

7. The method of claim 4, wherein the first server and the second server, which possesses the third secret share, generate the 1-1st secret share using the second secret share and the third secret share.

8. A computing device, comprising:
a processor; and
a memory communicating with the processor,
wherein the memory stores instructions for causing the processor to perform operations, and
the operations include:
in a computing device of a secret information management system composed of the computing device,
receiving a first secret share from among a plurality of secret shares for a secret key, a first additive share from among additive shares for the secret key, and a public key for the secret key by using a first terminal;
generating a temporary key using the received public key as a coefficient for a random number;
generating encrypted information by encrypting the secret information using an encryption key derived from the random number and the public key;
storing the received first additive share and the public key in a database of the first terminal; and
transmitting the generated temporary key and the encrypted information to a first server that possesses a second secret share and a second additive share.

9. The computing device of claim 8, further comprising:
an operation of performing authentication using secret information stored in the database.

10. The computing device of claim 9, further comprising:
storing the temporary key and the encrypted information in the database,
wherein the operation of performing the authentication includes:
extracting the temporary key, the first additive share, and the encrypted information from the database;
requesting and receiving a first operation result of the temporary key and the second additive share transmitted from the first server;
generating the secret information by decrypting the encrypted information using a second operation result of the first additive share and the temporary key and the received first operation result; and
performing authentication using the generated secret information.

11. The computing device of claim 8, further comprising:
an operation of requesting a generation of a new secret share for the secret key using a second terminal different from the first terminal;
an operation of receiving, in response to the request, a newly generated 1-1st secret share using a previously generated second secret share and third secret share for the secret key, a 1-1st additive share among the additive shares for the secret key, and a public key for the secret key; and
an operation of storing the received 1-1st additive share and public key in a database of the second terminal.

12. The computing device of claim 11, further comprising:
an operation of receiving the temporary key and the encrypted information transmitted by the first terminal from the first server; and
an operation of storing the received temporary key and encrypted information in the database of the second terminal.

13. The computing device of claim 12, further comprising:
an operation of extracting the temporary key, the 1-1st additive share, and the encrypted information from the database of the second terminal;
an operation of requesting and receiving a 1-1st operation result of the temporary key and a 2-1st additive share from the first server;
an operation of generating the secret information by decrypting the extracted encrypted information using the 2-1st operation result of the 1-1st additive share and the temporary key, and the received 1-1st operation result; and
an operation of storing the generated secret information in the database of the second terminal.

14. The computing device of claim 11, wherein the first server and the second server, which possesses the third secret share, generate the 1-1st secret share using the second secret share and the third secret share.
